(19) United States
(12) Patent Application Publication
(10) Pub. No.: US 2026/0218902 A1
(43) Pub. Date: Jul. 30, 2026

(54) TUBULAR BODY FOR COMBUSTOR, COMBUSTOR, AND GAS TURBINE

(71) Applicant: MITSUBISHI HEAVY INDUSTRIES, LTD., Tokyo (JP)

(72) Inventors: Kenta TANIGUCHI, Tokyo (JP); Norihiko MOTOYAMA, Tokyo (JP)

(21) Appl. No.: 19/144,183

(22) PCT Filed: Feb. 14, 2024
(86) PCT No.: PCT/JP2024/005051

§ 371 Date: Jun. 27, 2025

(30) Foreign Application Priority Data
Feb. 22, 2023 (JP) 2023-026393

(51) Int. Cl. F23R 3/00; F02C 3/04; F23R 3/28

(52) U.S. Cl. CPC F23R 3/005; F02C 3/04; F23R 3/28; F23R 2900/03043

(57) ABSTRACT

A tubular body for a combustor includes: a first cooling passage formed in an upstream-side region located inside a wall part of the tube body and positioned on the upstream side of the tube body, that has a supply port opening on the outer peripheral surface of the tube body; a second cooling passage formed in a downstream-side region located inside the wall part and positioned on the downstream side of the tube body, and having a discharge port; and a first wall disposed between the supply port and the discharge port and extending along the outer peripheral surface in the circumferential direction of the tube body. The first wall has a first wall part, the base end portion of which is connected to the outer peripheral surface, and a first discontinuous part in which the first wall part is discontinuous in the circumferential direction.

### TECHNICAL FIELD

The present disclosure relates to a tubular body for a combustor, a combustor, and a gas turbine.

The present application claims priority based on Japanese Patent Application No. 2023-026393 filed in Japan on Feb. 22, 2023, the contents of which are incorporated herein by reference.

### BACKGROUND ART

A combustor of a gas turbine includes a transition piece that delivers a high-temperature combustion gas to a turbine. PTL 1 discloses a structure in which two types of cooling passages are formed in a wall portion of a transition piece to cool the wall portion of the transition piece.

A first cooling passage is formed in an upstream-side region of the transition piece, which is located on an upstream side in a circulation direction of the combustion gas flowing inside the transition piece. In the first cooling passage, air in a casing internal space of the gas turbine in which the transition piece is disposed is introduced as first cooling air for cooling the upstream-side region of the transition piece. For this reason, the first cooling passage includes a supply port that is open to an outer peripheral surface of the transition piece and through which the first cooling air is introduced.

Meanwhile, a second cooling passage is formed in a downstream-side region of the transition piece, which is located on a downstream side in the circulation direction of the combustion gas with respect to the upstream-side region described above. A part of compressed air compressed in the compressor of the gas turbine is boosted by a boosting device and is introduced into the second cooling passage as second cooling air for cooling the downstream-side region of the transition piece. The second cooling air introduced into the second cooling passage cools the downstream-side region and then is discharged to the casing internal space of the gas turbine in which the transition piece is disposed. For this reason, the second cooling passage includes a discharge port that is open to the outer peripheral surface of the transition piece and through which the second cooling air is discharged to the casing internal space. The discharge port of the second cooling passage is disposed on the downstream side in the circulation direction of the combustion gas with respect to the supply port of the first cooling passage. The air discharged from the discharge port is high-temperature air heated by the second cooling air cooling the transition piece as described above.

PTL 1 discloses a configuration in which a first wall portion that protrudes from the outer peripheral surface of the transition piece and that extends over an entire circumference of the transition piece in a circumferential direction is provided between the supply port of the first cooling passage and the discharge port of the second cooling passage so that the high-temperature air discharged from the discharge port of the second cooling passage into the casing internal space does not enter the first cooling passage from the supply port, and a second wall portion that protrudes from the outer peripheral surface of the transition piece and that extends over the entire circumference of the transition piece in the circumferential direction is provided on an upstream side in the circulation direction of the combustion gas with respect to the supply port of the first cooling passage.

### CITATION LIST

### Patent Literature

[PTL 1] International Publication No. WO2016/013585

### SUMMARY OF INVENTION

### Technical Problem

However, in the combustor disclosed in PTL 1 described above, the first wall portion and the second wall portion are provided over the entire circumference of the transition piece in the circumferential direction, and thus thermal stress is generated due to a temperature difference between the transition piece heated by the heat from the combustion gas and the first wall portion and the second wall portion. Therefore, there is a possibility that the low cycle fatigue strength decreases and the reliability of the transition piece decreases.

In view of the above-described circumstances, an object of at least one embodiment of the present disclosure is to suppress a decrease in reliability of a tubular body for a combustor.

### Solution to Problem

(1) At least one embodiment of the present disclosure relates to a tubular body for a combustor, in which a combustion gas generated by combustion of fuel is flowable, the tubular body including: a tube body extending along an axis; a first cooling passage that is formed in an upstream-side region located on an upstream side of the tube body in a wall portion of the tube body, that has a supply port that is open to an outer peripheral surface of the tube body, and that is capable of cooling the upstream-side region by receiving a first cooling fluid introduced from a space outside the tube body through the supply port; a second cooling passage that is formed in a downstream-side region located on a downstream side of the tube body with respect to the upstream-side region in the wall portion, that is capable of cooling the downstream-side region by receiving supply of a second cooling fluid different from the first cooling fluid, and that has a discharge port that is open to the outer peripheral surface at a position different from the supply port along the axis and through which the second cooling fluid is dischargeable to the space outside the tube body; and a first wall that is disposed between the supply port and the discharge port and that extends in a circumferential direction of the tube body along the outer peripheral surface, in which the first wall includes a first wall portion that has a base end portion connected to the outer peripheral surface and extending in a direction away from the outer peripheral surface and that extends in the circumferential direction, and a first discontinuous portion in which the first wall portion is discontinuous in the circumferential direction.

(2) At least one embodiment of the present disclosure relates to a combustor including: the tubular body for a combustor according to the configuration of (1); and a burner that injects fuel.

(3) At least one embodiment of the present disclosure relates to a gas turbine including: the combustor according to the configuration of (2); a compressor that generates compressed air to be delivered to the combustor; and a turbine including a rotor that rotates by means of a combustion gas delivered from the combustor.

### Advantageous Effects of Invention

According to at least one embodiment of the present disclosure, it is possible to suppress the decrease in reliability of the tubular body for a combustor.

### BRIEF DESCRIPTION OF DRAWINGS

FIG. 1 is a schematic view illustrating an overall configuration of a gas turbine according to an embodiment.

FIG. 2 is a view illustrating an example of a combustor of the gas turbine according to the embodiment and a peripheral structure thereof.

FIG. 3 is a schematic view illustrating a tubular body for a combustor according to the embodiment.

FIG. 4 is a schematic view of a mixing prevention portion according to the embodiment when viewed from a radial outer side of the tubular body for a combustor.

FIG. 5 is a cross-sectional view taken along line V-V of FIG. 4.

FIG. 6 is a cross-sectional view taken along line VI-VI of FIG. 4.

FIG. 7 is a cross-sectional view taken along line VII-VII of FIG. 4.

FIG. 8 is a cross-sectional view taken along line VIII-VIII of FIG. 4.

FIG. 9 is a view illustrating a discontinuous portion.

FIG. 10 is a view illustrating a positional relationship between the discontinuous portion and a welding portion of a transition piece.

FIG. 11 is a schematic view illustrating the mixing prevention portion and the transition piece when viewed from a downstream side in a circulation direction of a combustion gas along an axis of the transition piece.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples.

For example, the expression representing a relative or absolute disposition such as “in a certain direction”, “along a certain direction”, “parallel”, “orthogonal”, “center”, “concentric”, or “coaxial” not only strictly represents such a disposition, but also represents a state where the disposition is relatively displaced with a tolerance or at an angle or a distance to such an extent that the same function can be obtained.

For example, the expression representing that matters are in an equal state such as “same”, “equal”, or “homogeneous” not only strictly represents an equal state, but also represents a state where a difference exists with a tolerance or to such an extent that the same function can be obtained.

For example, the expression representing a shape such as a quadrangular shape or a cylindrical shape not only represents a shape such as a quadrangular shape or a cylindrical shape in a geometrically strict sense, but also represents shapes including an uneven portion or a chamfered portion within a range in which the same effect can be obtained.

In addition, the expression of “provided with”, “equipped with”, “include”, or “have” one component is not an exclusive expression excluding the presence of other components.

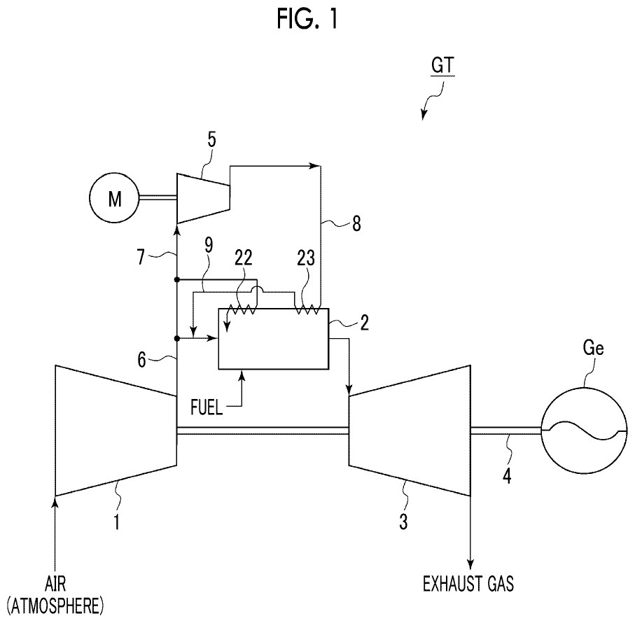

A tubular body for a combustor, a combustor, and a gas turbine according to the embodiment will be described with reference to FIGS. 1 to 11.

FIG. 1 is a schematic view illustrating an overall configuration of the gas turbine according to the embodiment.

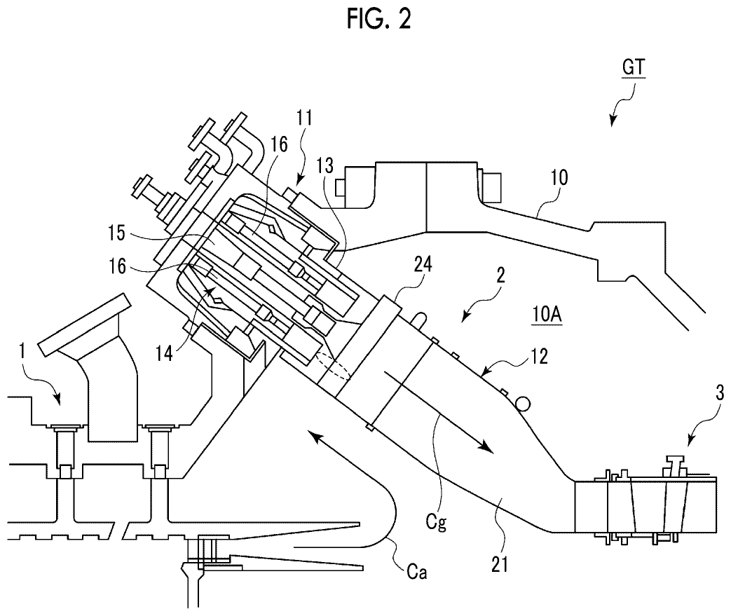

FIG. 2 is a view illustrating an example of the combustor of the gas turbine according to the embodiment and a peripheral structure thereof.

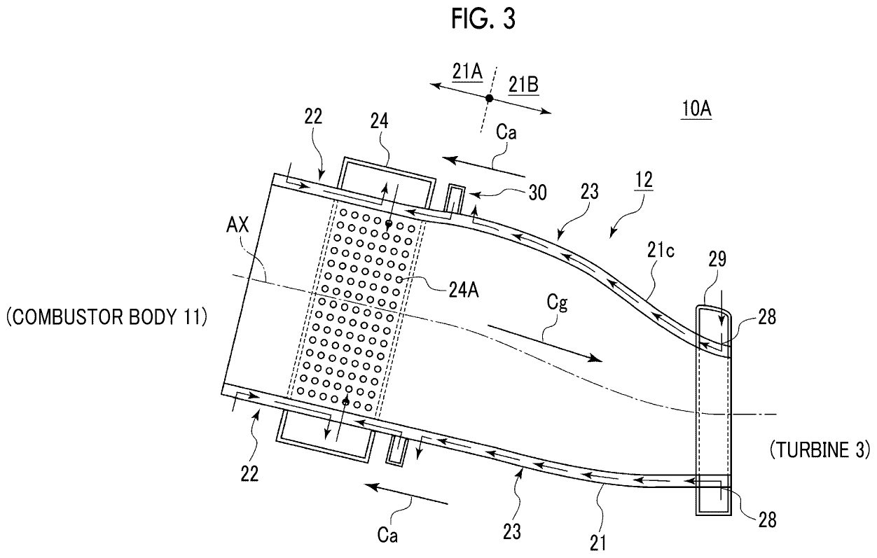

FIG. 3 is a schematic view illustrating the tubular body for a combustor according to the embodiment.

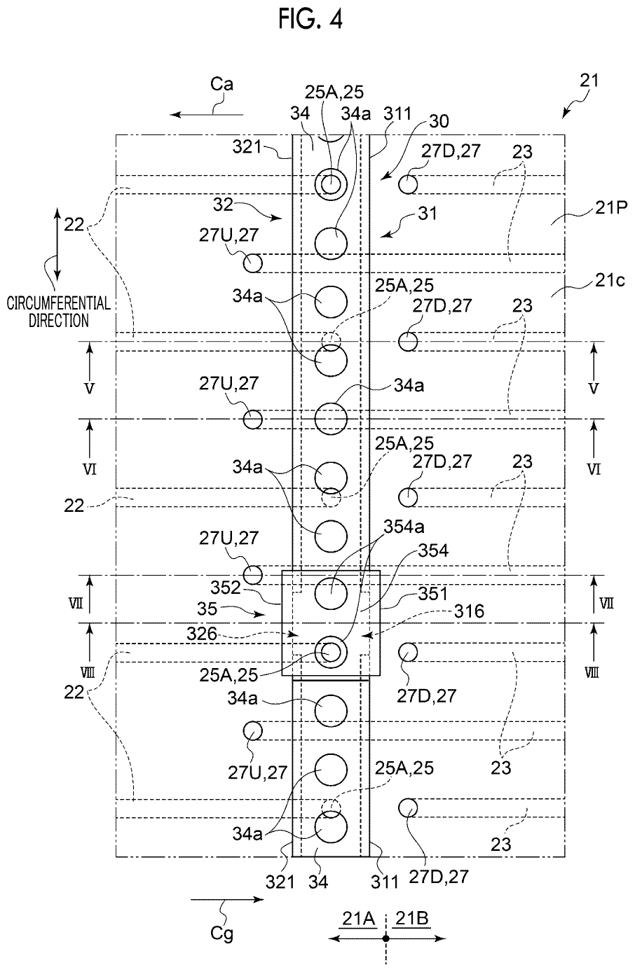

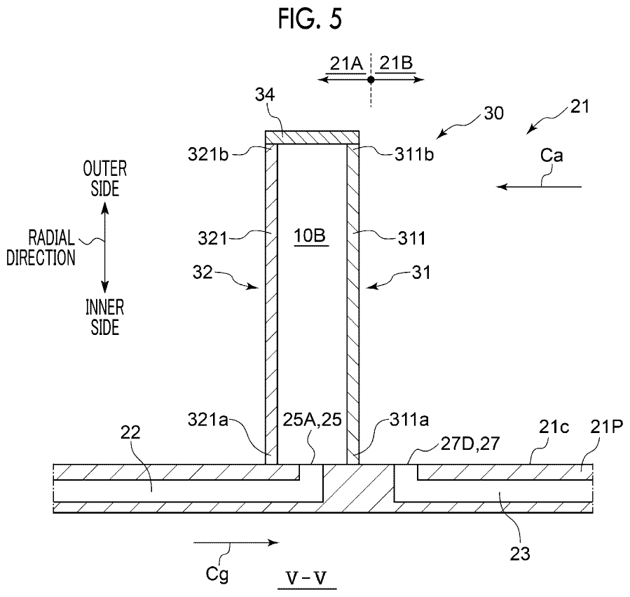

FIG. 4 is a schematic view of a mixing prevention portion according to the embodiment when viewed from a radial outer side of the tubular body for a combustor. FIG. 5 is a cross-sectional view taken along line V-V of FIG. 4.

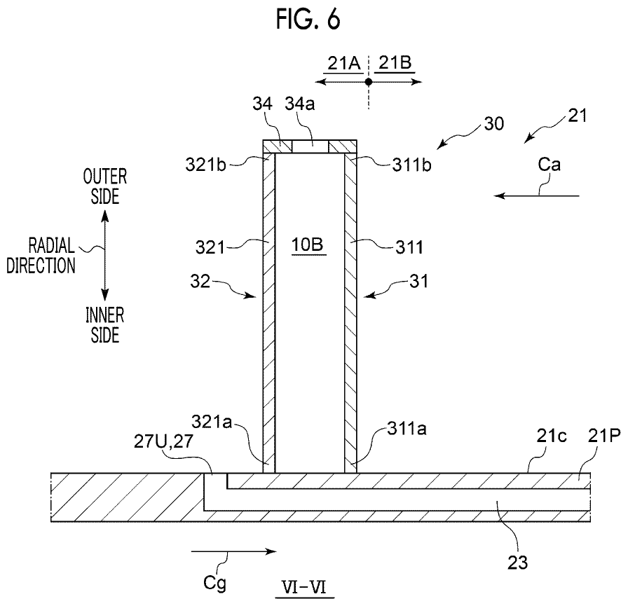

FIG. 6 is a cross-sectional view taken along line VI-VI of FIG. 4.

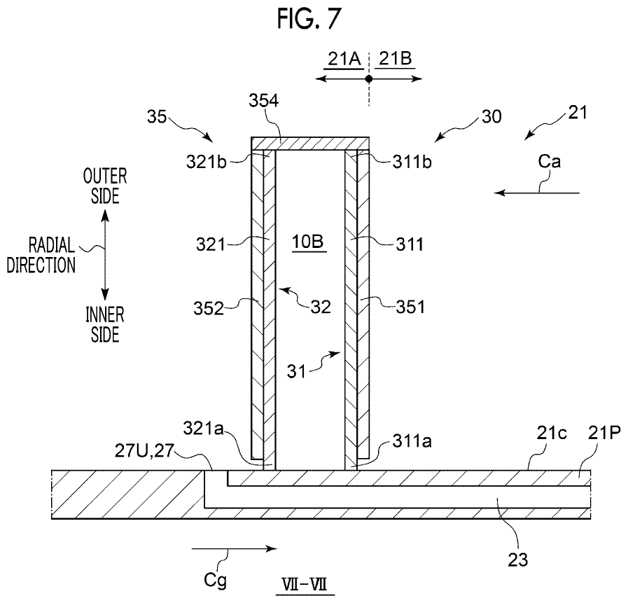

FIG. 7 is a cross-sectional view taken along line VII-VII of FIG. 4.

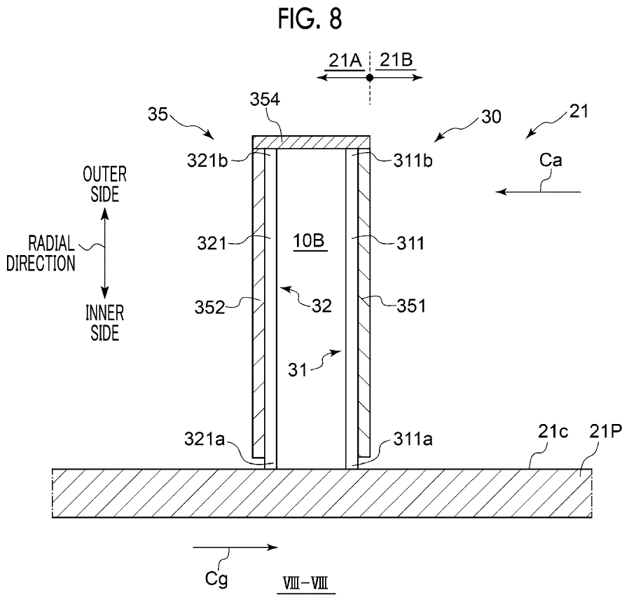

FIG. 8 is a cross-sectional view taken along line VIII-VIII of FIG. 4.

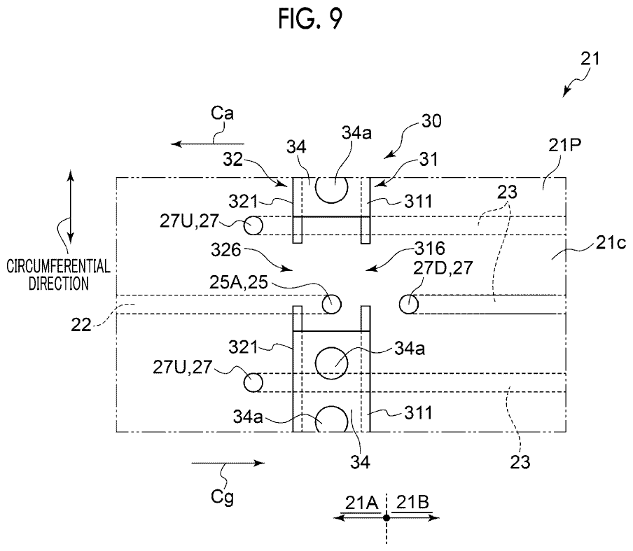

FIG. 9 is a view illustrating a discontinuous portion.

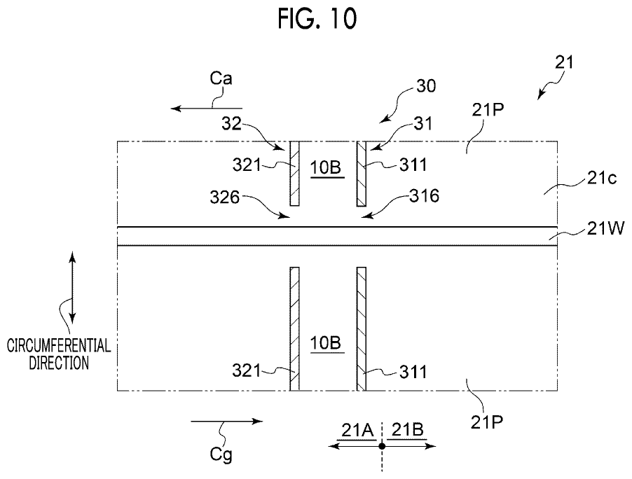

FIG. 10 is a view illustrating a positional relationship between the discontinuous portion and a welding portion of a transition piece.

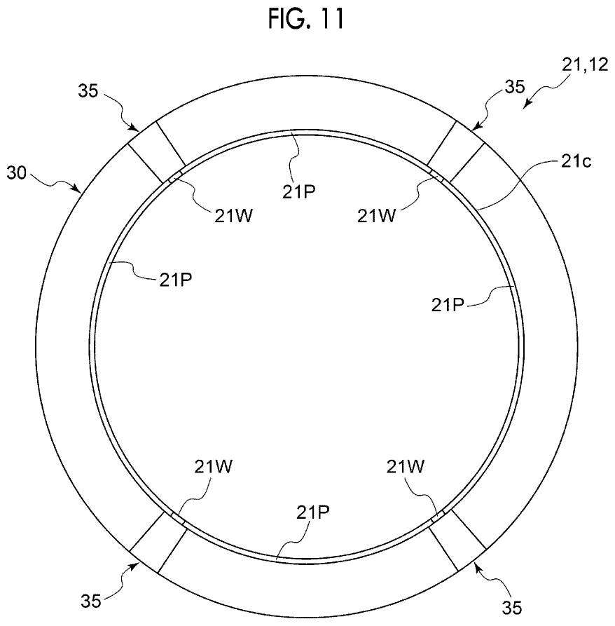

FIG. 11 is a schematic view illustrating the mixing prevention portion and the transition piece when viewed from a downstream side in a circulation direction of a combustion gas along an axis of the transition piece.

As illustrated in FIG. 1, a gas turbine GT according to the present embodiment includes a compressor 1, a combustor 2, and a turbine 3.

The compressor 1 generates compressed air by taking in air as a working fluid from an air intake port.

The combustor 2 is connected to a discharge port of the compressor 1. The combustor 2 injects fuel into the compressed air discharged from the compressor 1, to generate a high-temperature and high-pressure combustion gas.

The turbine 3 converts thermal energy of the combustion gas delivered from the combustor 2 into rotational energy of a rotor 4 to generate a driving force. The turbine 3 transmits the generated driving force to a generator Ge connected to the rotor 4.

The gas turbine GT according to the present embodiment is further provided with a boosting device 5 that bleeds a part of the compressed air compressed by the compressor 1 and that boosts the bled air to a pressure higher than the pressure of the compressed air. The boosting device 5 is provided in a branch flow channel 7 that branches off from the middle of a compressed air supply flow channel 6 for supplying the compressed air from the compressor 1 to the combustor 2 and that bleeds a part of the compressed air, and is driven by, for example, an electric motor M.

The bled boosted air boosted by the boosting device 5 is supplied to the combustor 2 through a boosted air flow channel 8, and is used as air (hereinafter, referred to as cooling air) for cooling a transition piece 21 of the combustor 2 which will be described later. The cooling air used for cooling the transition piece 21 is returned to the compressed air supply flow channel 6 through a return flow channel 9, merges with a main stream of the compressed air flowing through the compressed air supply flow channel 6, and then is reused as combustion air for the combustion of the fuel in the combustor 2.

That is, the gas turbine GT according to the present embodiment has a recovery type air cooling structure (closed cooling cycle structure) in which a part of the compressed air that is supplied from the compressor 1 and that is used as the combustion air in the combustor 2 is used as the cooling air for cooling the transition piece 21 of the combustor 2, and then the cooling air is recovered and reused as the combustion air in the combustor 2 together with the main stream of the compressed air. As illustrated in FIG. 1, a part of the compressed air bled from the main stream (compressed air supply flow channel 6) is not limited to being used only for cooling the transition piece 21 of the combustor 2, and may be used, for example, for cooling a stator blade or a rotor blade of the turbine 3 in addition to cooling the transition piece 21 of the combustor 2.

The combustor 2 has a substantially cylindrical external appearance, and is disposed in a casing internal space 10A formed mainly in a casing 10 (casing) of the gas turbine GT, for example, as illustrated in FIG. 2. The compressed air compressed in the compressor 1 is introduced to fill the casing internal space 10A in which the combustor 2 is disposed. The combustor 2 includes a combustor body 11 and a tubular body for a combustor 12.

The combustor body 11 functions as a combustion chamber that causes the supplied fuel and the compressed air, which is discharged from the compressor 1, to react with each other. The tubular body for a combustor 12 delivers the combustion gas that has flowed in from the combustor body 11 to the turbine 3.

The combustor body 11 includes a cylindrical inner tube 13, and a burner 14 that is disposed in the inner tube 13 and that injects fuel.

One opening of the inner tube 13 is an upstream-side opening for introducing the compressed air that has filled the casing internal space 10A into the inner tube 13. The other opening of the inner tube 13 is a downstream-side opening, and the transition piece 21 (which will be described later) is connected thereto.

The burner 14 includes a pilot burner 15 and a main burner 16. The pilot burner 15 is provided along a central axis of the inner tube 13. The pilot burner 15 injects the fuel supplied from the outside to perform diffusion combustion of the fuel. A plurality of main burners 16 are provided in the inner tube 13. The plurality of main burners 16 are arranged at intervals in a circumferential direction of the inner tube 13 to surround the pilot burner 15. Each main burner 16 extends parallel to the central axis of the inner tube 13. The main burner 16 injects the fuel, generates a premixed gas by mixing the fuel and the compressed air in advance, and then injects the premixed gas to perform premixed combustion.

As illustrated in FIGS. 2 and 3, the tubular body for a combustor 12 includes the transition piece (tube body) 21, a first cooling passage 22, a second cooling passage 23, and an acoustic liner 24.

The transition piece 21 extends along an axis AX, and accelerates a flow rate of a combustion gas Cg that has flowed in from the combustor body 11 inside to introduce the combustion gas Cg into the turbine 3. One opening of the transition piece 21 is connected to the above-described downstream-side opening of the inner tube 13 (see FIG. 2) of the combustor body 11. The other opening of the transition piece 21 is connected to the turbine 3. The combustion gas Cg that has flowed from the combustor body 11 flows inside the transition piece 21. In FIGS. 3 to 10, inside the transition piece 21, the combustion gas Cg flows from a left side (upstream side) to a right side (downstream side) of a paper surface. In a space outside the transition piece 21, that is, in the casing internal space 10A, compressed air Ca discharged from the compressor 1 flows in a direction opposite to a circulation direction of the combustion gas Cg in the transition piece 21 to head for the above-described upstream-side opening of the inner tube 13.

The first cooling passage 22 is formed in an upstream-side region 21A located on an upstream side in the circulation direction of the combustion gas Cg in a wall portion of the transition piece 21. The first cooling passage 22 has a supply port 25 that is open to an outer peripheral surface 21c of the transition piece 21. As a result, the first cooling passage 22 cools the upstream-side region 21A of the transition piece 21 by introducing the compressed air (fluid) Ca as first cooling air (first cooling fluid) from the casing internal space 10A through the supply port 25.

The first cooling passage 22 according to the present embodiment extends along the axis AX direction of the transition piece 21. A plurality of first cooling passages 22 are arranged at intervals in a circumferential direction of the transition piece 21.

One supply port 25 of each first cooling passage 22 is provided on each of both sides of the acoustic liner 24 provided in the upstream-side region 21A of the transition piece 21 in the circulation direction of the combustion gas Cg. Supply ports 25A (hereinafter, referred to as downstream-side supply ports 25A) of the plurality of first cooling passages 22 located on the downstream side in the circulation direction of the combustion gas Cg with respect to the acoustic liner 24 are arranged in a row in the circumferential direction of the transition piece 21.

Each first cooling passage 22 has a discharge port (not illustrated) that is open to the outer peripheral surface 21c of the transition piece 21 and that discharges the first cooling air to the outside of the transition piece 21. The discharge port (not illustrated) of the first cooling passage 22 is open to the inside of the acoustic liner 24. That is, the first cooling air cools the upstream-side region 21A of the transition piece 21, and then is discharged into the acoustic liner 24.

The second cooling passage 23 is formed in a downstream-side region 21B that is located continuously on the downstream side in the circulation direction of the combustion gas Cg with respect to the upstream-side region 21A of the transition piece 21 in the wall portion of the transition piece 21. The second cooling passage 23 cools the downstream-side region 21B of the transition piece 21 by receiving supply of the bled boosted air boosted by the boosting device 5 (see FIG. 1) as second cooling air (second cooling fluid) to the second cooling passage 23. The second cooling passage 23 includes a second cooling passage 23 having a downstream-side discharge port 27D that is open to the downstream side with respect to the downstream-side supply port 25A on the outer peripheral surface 21c of the transition piece 21 and through which the second cooling air is discharged into the casing internal space 10A, and a second cooling passage 23 having an upstream-side discharge port 27U that is open to the upstream side with respect to the downstream-side supply port 25A on the outer peripheral surface 21c of the transition piece 21 and through which the second cooling air is discharged into the casing internal space 10A. In a case where it is not necessary to particularly distinguish between the downstream-side discharge port 27D and the upstream-side discharge port 27U from each other or in a case where the downstream-side discharge port 27D and the upstream-side discharge port 27U are collectively referred to, the downstream-side discharge port 27D and the upstream-side discharge port 27U may be simply referred to as a discharge port 27.

The second cooling passage 23 according to the present embodiment extends along the axis AX direction of the transition piece 21. A plurality of second cooling passages 23 are arranged at intervals in the circumferential direction of the transition piece 21.

The discharge port 27 of each second cooling passage 23 is provided at a first end portion in a longitudinal direction of the second cooling passage 23 located on the upstream side in the circulation direction of the combustion gas Cg. The upstream-side discharge ports 27U of the plurality of second cooling passages 23 are arranged in a row in the circumferential direction of the transition piece 21. The downstream-side discharge ports 27D of the plurality of second cooling passages 23 are arranged in a row in the circumferential direction of the transition piece 21.

Each second cooling passage 23 has a supply port 28 that is open to the outer peripheral surface 21c of the transition piece 21 and through which the second cooling air is introduced into the second cooling passage 23. The supply port 28 of the second cooling passage 23 is provided at a second end portion of the second cooling passage 23 in the longitudinal direction, and is located at a downstream-side end portion of the transition piece 21 located on the turbine 3 side.

The outer peripheral surface 21c of the downstream-side end portion of the transition piece 21 is provided with an annular passage portion 29 (manifold) that is formed over the entire circumferential direction of the transition piece 21, that collectively covers the supply ports 28 of the plurality of second cooling passages 23, and that forms an introduction space communicating with the supply ports 28 of the second cooling passages 23. The introduction space of the annular passage portion 29 is formed not to communicate with the casing internal space 10A. As a result, the second cooling air (bled boosted air boosted by the boosting device 5) is supplied to each second cooling passage 23 from the supply port 28 of each second cooling passage 23 via the annular passage portion 29.

The second cooling air supplied to the second cooling passage 23 cools the downstream-side region 21B of the transition piece 21, and then is discharged into the casing internal space 10A. Since the second cooling air is heated by cooling the wall portion of the transition piece 21 in the second cooling passage 23, when the second cooling air is discharged from the discharge port 27 of the second cooling passage 23, the second cooling air becomes high-temperature air (high-temperature fluid) having a temperature higher than a temperature of the second cooling air in the supply port 28 of the second cooling passage 23 and a temperature of the compressed air Ca that fills the casing internal space 10A. The high-temperature air (second cooling air) discharged into the casing internal space 10A merges with the compressed air Ca that fills the casing internal space 10A, and is reused as the combustion air.

The acoustic liner 24 is provided on an outer periphery of the transition piece 21 in the upstream-side region 21A. A part of the acoustic liner 24 is formed by the wall portion of the transition piece 21. An internal space of the acoustic liner 24 communicates with the inside of the transition piece 21 through a large number of acoustic holes 24A formed to penetrate the wall portion of the transition piece 21. For this reason, the first cooling passage 22 described above is provided at a position that does not interfere with the acoustic hole 24A. The acoustic liner 24 reduces combustion vibration (self-excited vibration that occurs due to feedback of pressure fluctuation, speed fluctuation, and heat generation rate fluctuation inside the combustor 2) of the gas turbine GT.

Since the acoustic liner 24 is provided with the acoustic holes 24A as described above, the first cooling air discharged into the acoustic liner 24 from the discharge port (not illustrated) of the first cooling passage 22 described above flows into the inside of the transition piece 21 through the acoustic holes 24A.

### (Mixing Prevention Portion 30)

The tubular body for a combustor 12 according to the present embodiment includes the mixing prevention portion 30.

The mixing prevention portion 30 is used for preventing the high-temperature air (second cooling air) discharged from the discharge port 27 of the second cooling passage 23 to the casing internal space 10A from flowing into the supply port 25 of the first cooling passage 22. The mixing prevention portion 30 according to the embodiment includes a first wall 31, a second wall 32, a top plate 34, and a cover portion 35.

### (First Wall 31)

The first wall 31 according to the embodiment is disposed between the downstream-side supply port 25A, which is the supply port 25 of the first cooling passage 22, and the downstream-side discharge port 27D, which is the discharge port 27 of the second cooling passage 23, and extends in the circumferential direction of the transition piece (tube body) 21 along the outer peripheral surface 21c of the transition piece 21. The first wall 31 according to the embodiment includes a first wall portion 311 that has a base end portion 311a connected to the outer peripheral surface 21c of the transition piece 21 and extending in a direction away from the outer peripheral surface 21c, that is, outward in the radial direction of the tubular body for a combustor 12, and that extends in the circumferential direction of the transition piece 21, and at least one first discontinuous portion 316 in which the first wall portion 311 is discontinuous in the circumferential direction of the transition piece 21. That is, in the first wall 31 according to the embodiment, the first wall portion 311 is interrupted in the circumferential direction of the transition piece 21 in the at least one first discontinuous portion 316.

### (Second Wall 32)

The second wall 32 according to the embodiment is disposed on a side opposite to the first wall 31 across the downstream-side supply port 25A, which is the supply port 25 of the first cooling passage 22, along the axis AX of the transition piece 21, and extends in the circumferential direction of the transition piece 21 along the outer peripheral surface 21c of the transition piece 21. The second wall 32 according to the embodiment includes a second wall portion 321 that has a base end portion 321a connected to the outer peripheral surface 21c of the transition piece 21 and extending in a direction away from the outer peripheral surface 21c, that is, outward in the radial direction of the tubular body for a combustor 12 and that extends in the circumferential direction of the transition piece 21, and a second discontinuous portion 326 in which the second wall portion 321 is discontinuous in the circumferential direction. That is, in the second wall 32 according to the embodiment, the second wall portion 321 is interrupted in the circumferential direction of the transition piece 21 in the at least one second discontinuous portion 326.

In the mixing prevention portion 30 according to the embodiment, a region in the circumferential direction of the transition piece 21 in which the first discontinuous portion 316 is present and a region in the circumferential direction of the transition piece 21 in which the second discontinuous portion 326 is present coincide with each other.

### (Top Plate 34)

The top plate 34 according to the embodiment is a member that is connected to a distal end portion 311b of the first wall portion 311 on a side opposite to the base end portion 311a and to a distal end portion 321b of the second wall portion 321 on a side opposite to the base end portion 321a and that partially covers a space (casing internal space 10A) outside the transition piece (tube body) 21 interposed between the first wall portion 311 and the second wall portion 321.

The top plate 34 according to the embodiment is provided with a plurality of openings 34a through which the compressed air Ca inside the casing internal space 10A outside a space 10B is flowable into the space 10B surrounded by the first wall portion 311, the second wall portion 321, the outer peripheral surface 21c of the transition piece 21, and the top plate 34 when viewed in the circumferential direction of the transition piece 21.

The top plate 34 according to the embodiment is not provided in the regions in the circumferential direction in which the first discontinuous portion 316 and the second discontinuous portion 326 are present. That is, the top plate 34 is interrupted in the circumferential direction of the transition piece 21 in the regions in the circumferential direction in which the first discontinuous portion 316 and the second discontinuous portion 326 are present. A top plate 354 of the cover portion 35, which will be described later, is disposed in the region in the circumferential direction.

### (Cover Portion 35)

The cover portion 35 according to the embodiment includes a first cover member 351 that is disposed to cover at least a part of the first discontinuous portion 316 in the circumferential direction when viewed along the axis AX, a second cover member 352 that is disposed to cover at least a part of the second discontinuous portion 326 in the circumferential direction when viewed along the axis AX, and the top plate 354 that connects end portions of the first cover member 351 and the second cover member 352 that are on the radial outer side.

The first cover member 351 is fixed to the first wall portion 311 disposed on one side in the circumferential direction across the first discontinuous portion 316, and is not fixed to the first wall portion 311 disposed on the other side in the circumferential direction across the first discontinuous portion 316. For example, in the example illustrated in FIG. 4, the first cover member 351 is fixed to the first wall portion 311 disposed on an upper side in the drawing across the first discontinuous portion 316, and is not fixed to the first wall portion 311 disposed on a lower side in the drawing across the first discontinuous portion 316. Therefore, for example, the influence of the thermal elongation of the first wall portion 311 disposed on the upper side illustrated in FIG. 4 across the first discontinuous portion 316 is prevented from being transmitted to the first wall portion 311 disposed on the lower side illustrated in FIG. 4 across the first discontinuous portion 316, via the first cover member 351.

In the first cover member 351 according to the embodiment, a dimension Lc1 of the first cover member 351 in the circumferential direction may be larger than a dimension Lg1 of the first discontinuous portion 316 in the circumferential direction.

The second cover member 352 is fixed to the second wall portion 321 disposed on one side in the circumferential direction across the second discontinuous portion 326, and is not fixed to the second wall portion 321 disposed on the other side in the circumferential direction across the second discontinuous portion 326. For example, in the example illustrated in FIG. 4, the second cover member 352 is fixed to the second wall portion 321 disposed on the upper side in the drawing across the second discontinuous portion 326, and is not fixed to the second wall portion 321 disposed on the lower side in the drawing across the second discontinuous portion 326. Therefore, for example, the influence of the thermal elongation of the second wall portion 321 disposed on the upper side illustrated in FIG. 4 across the second discontinuous portion 326 is prevented from being transmitted to the second wall portion 321 disposed on the lower side illustrated in FIG. 4 across the second discontinuous portion 326, via the second cover member 352.

In the second cover member 352 according to the embodiment, a dimension Lc2 of the second cover member 352 in the circumferential direction may be larger than a dimension Lg2 of the second discontinuous portion 326 in the circumferential direction.

The top plate 354 is disposed to cover the regions in the circumferential direction in which the first discontinuous portion 316 and the second discontinuous portion 326 are present, from the radial outer side. The top plate 354 is provided with at least one opening 354a that penetrates the top plate 354 in the radial direction.

The top plate 354 is fixed to the top plate 34 disposed on one side in the circumferential direction across the first discontinuous portion 316 and the second discontinuous portion 326, and is not fixed to the top plate 34 disposed on the other side in the circumferential direction across the first discontinuous portion 316 and the second discontinuous portion 326. For example, in the example illustrated in FIG. 4, the top plate 354 is fixed to the top plate 34 disposed on the upper side illustrated in FIG. 4 across the first discontinuous portion 316 and the second discontinuous portion 326, and is not fixed to the top plate 34 disposed on the lower side illustrated in FIG. 4 across the first discontinuous portion 316 and the second discontinuous portion 326. Therefore, for example, the influence of the thermal elongation of the top plate 34 disposed on the upper side illustrated in FIG. 4 across the first discontinuous portion 316 and the second discontinuous portion 326 is prevented from being transmitted to the top plate 34 disposed on the lower side illustrated in FIG. 4 across the first discontinuous portion 316 and the second discontinuous portion 326, via the top plate 354 of the cover portion 35.

That is, the cover portion 35 according to the embodiment is movable with respect to the first wall portion 311 disposed on the other side in the circumferential direction across the first discontinuous portion 316, the second wall portion 321 disposed on the other side in the circumferential direction across the second discontinuous portion 326, and the top plate 34 disposed on the other side in the circumferential direction across the first discontinuous portion 316 and the second discontinuous portion 326.

In the tubular body for a combustor 12 configured in this way, the compressed air Ca in the casing internal space 10A can flow into the space 10B surrounded by the first wall portion 311, the second wall portion 321, the outer peripheral surface 21c of the transition piece 21, and the top plate 34 when viewed in the circumferential direction of the transition piece 21 through the plurality of openings 34a and 354a provided in the top plates 34 and 354 of the mixing prevention portion 30. Then, the compressed air Ca that has flowed into the space 10B can flow into the first cooling passage 22 from the downstream-side supply port 25A that is open toward the space 10B.

In contrast, in the tubular body for a combustor 12, the high-temperature air (second cooling air), which is discharged from the discharge port 27 of the second cooling passage 23, is prevented from flowing into the space 10B by the mixing prevention portion 30.

As a result, in the tubular body for a combustor 12 according to the embodiment, the temperature rise of the first cooling air flowing into the first cooling passage 22 from the downstream-side supply port 25A can be suppressed, and thus the decrease in cooling efficiency in the upstream-side region can be suppressed.

In addition, in the tubular body for a combustor 12 according to the embodiment, since the first wall 31 has the first discontinuous portion 316, and the second wall 32 has the second discontinuous portion 326, the thermal stress generated by the temperature difference between the transition piece 21 heated by the heat from the combustion gas Cg and the first wall portion 311 and the second wall portion 321 can be suppressed as compared with a case where the first wall portion 311 and the second wall portion 321 are continuously provided over the entire circumference of the transition piece 21 in the circumferential direction. As a result, the decrease in reliability of the tubular body for a combustor 12 can be suppressed.

### (Regarding Positional Relationship Between Each of Discontinuous Portions 316 and 326 and Welding Portion 21W of Transition Piece 21)

As illustrated in FIGS. 10 and 11, in the tubular body for a combustor 12 according to the embodiment, the transition piece 21 has a welding portion 21W extending along the axis AX in at least one or more locations in the circumferential direction. That is, in the transition piece 21 according to the embodiment, plate-shaped members 21P in which a plurality of passages (first cooling passage 22 and second cooling passage 23) are formed are arranged in the circumferential direction, and end portions of the members 21P adjacent to each other in the circumferential direction are joined to each other by welding.

In the example illustrated in FIG. 11, four plate-shaped members 21P are arranged in the circumferential direction, and the end portions of the members 21P adjacent to each other in the circumferential direction are joined to each other by welding. Therefore, in the example illustrated in FIG. 11, the transition piece 21 has four welding portions 21W.

In the tubular body for a combustor 12 according to the embodiment, the positions of the first discontinuous portion 316 and the second discontinuous portion 326 in the circumferential direction may overlap the position of the welding portion 21W in the circumferential direction. That is, in the tubular body for a combustor 12 according to the embodiment, the first wall portion 311 and the second wall portion 321 that extend in the circumferential direction may not straddle the welding portion 21W extending along the axis AX.

In the example illustrated in FIG. 11, among the four welding portions 21W, for example, the positions in the circumferential direction of the four welding portions 21W illustrated in the drawing and the positions in the circumferential direction of the first discontinuous portion 316 and the second discontinuous portion 326 overlap each other.

As a result, for example, in the four welding portions 21W illustrated in the drawing, the first wall portion extending in the circumferential direction and the welding portion extending along the axis AX do not intersect with each other, and thus the thermal stress of the welding portion 21W can be suppressed.

The present disclosure is not limited to the above-described embodiments, and also includes a form in which modifications are added to the above-described embodiments or a form in which the embodiments are combined with each other as appropriate.

For example, in the tubular body for a combustor 12 according to the above-described embodiment, for example, the second cooling passage 23 having the upstream-side discharge port 27U is not an essential component. Therefore, in a case where the tubular body for a combustor 12 does not include the second cooling passage 23 having the upstream-side discharge port 27U, the second cover member 352 of the second wall 32 and the cover portion 35 need not be provided. In addition, in this case, the top plate 34 and the top plate 354 of the cover portion 35 need not be provided.

The contents described in each embodiment are understood, for example, as follows.

(1) A tubular body for a combustor 12 according to at least one embodiment of the present disclosure is a tubular body for a combustor 12 in which a combustion gas Cg generated by combustion of fuel is flowable. The tubular body for a combustor 12 according to at least one embodiment of the present disclosure includes a tube body (transition piece 21) extending along an axis AX. The tubular body for a combustor 12 according to at least one embodiment of the present disclosure includes a first cooling passage 22 that is formed in an upstream-side region 21A located on an upstream side of the tube body (transition piece 21) in a wall portion of the tube body (transition piece 21), that has a supply port 25 that is open to an outer peripheral surface 21c of the tube body (transition piece 21), and that is capable of cooling the upstream-side region 21A by receiving a first cooling fluid (compressed air Ca) introduced from a space (casing internal space 10A) outside the tube body (transition piece 21) through the supply port 25. The tubular body for a combustor 12 according to at least one embodiment of the present disclosure includes a second cooling passage that is formed in a downstream-side region 21B located on a downstream side of the tube body (transition piece 21) with respect to the upstream-side region 21A in the wall portion, that is capable of cooling the downstream-side region 21B by receiving supply of a second cooling fluid different from the first cooling fluid (compressed air Ca), and that has a discharge port that is open to the outer peripheral surface 21c at a position different from the supply port 25 (downstream-side supply port 25A) along the axis AX and through which the second cooling fluid is dischargeable to the space outside the tube body. The tubular body for a combustor according to at least one embodiment of the present disclosure includes a first wall 31 that is disposed between the supply port and the discharge port and that extends in the circumferential direction of the tube body (transition piece 21) along the outer peripheral surface. The first wall 31 includes a first wall portion 311 that has a base end portion 311a connected to the outer peripheral surface 21c and extending in a direction away from the outer peripheral surface 21c and that extends in the circumferential direction, and a first discontinuous portion 316 in which the first wall portion 311 is discontinuous in the circumferential direction.

According to the configuration of (1) described above, since the first wall portion 311 can prevent the second cooling fluid, which is discharged from the discharge port 27 after cooling the downstream-side region 21B, from flowing toward the supply port 25 (downstream-side supply port 25A), the decrease in cooling efficiency of the upstream-side region 21A can be suppressed. In addition, according to the configuration of (1) described above, since the first wall 31 has the first discontinuous portion 316, it is possible to suppress the thermal stress generated by the temperature difference between the tube body (transition piece 21) heated by the heat from the combustion gas Cg and the first wall portion 311, as compared with a case where the first wall portion 311 is continuously provided over the entire circumference of the tube body (transition piece 21) in the circumferential direction. As a result, the decrease in reliability of the tubular body for a combustor 12 can be suppressed.

(2) In some embodiments, in the configuration of (1) described above, a first cover member 351 that is disposed to cover at least a part of the first discontinuous portion 316 in the circumferential direction when viewed along the axis AX may be provided.

According to the configuration of (2) described above, since the first cover member 351 can prevent the second cooling fluid, which is discharged from the discharge port 27 after cooling the downstream-side region 21B, from flowing from the first discontinuous portion 316 toward the supply port 25 (downstream-side supply port 25A), the decrease in cooling efficiency of the upstream-side region 21A can be suppressed.

(3) In some embodiments, in the configuration of (2) described above, the first cover member 351 may be fixed to the first wall portion 311 disposed on one side in the circumferential direction across the first discontinuous portion 316, and may not be fixed to the first wall portion 311 disposed on the other side in the circumferential direction across the first discontinuous portion 316.

According to the configuration of (3) described above, since the influence of the thermal elongation of the first wall portion 311 disposed on one side in the circumferential direction across the first discontinuous portion 316 is not transmitted via the first cover member 351 to the first wall portion 311 disposed on the other side in the circumferential direction across the first discontinuous portion 316. As a result, the thermal stress generated by the temperature difference between the tube body (transition piece 21) heated by the heat from the combustion gas Cg and the first wall portion 311 can be suppressed, and the decrease in reliability of the tubular body for a combustor 12 can be suppressed.

(4) In some embodiments, in the configuration of (2) or (3) described above, a dimension Lc1 of the first cover member 351 in the circumferential direction may be larger than a dimension Lg1 of the first discontinuous portion 316 in the circumferential direction.

According to the configuration of (4) described above, since the first cover member 351 has the dimension in the circumferential direction required to cover the first discontinuous portion 316, the first cover member 351 can effectively prevent the second cooling fluid, which is discharged from the discharge port 27 after cooling the downstream-side region 21B, from flowing from the first discontinuous portion 316 toward the supply port 25 (downstream-side supply port 25A), and the decrease in cooling efficiency of the upstream-side region 21A can be effectively suppressed.

(5) In some embodiments, in the configuration of any one of (1) to (4) described above, the tube body (transition piece 21) may have a welding portion 21W extending along the axis AX in at least one or more locations in the circumferential direction. A position of the first discontinuous portion 316 in the circumferential direction may overlap a position of the welding portion 21W in the circumferential direction.

According to the configuration of (5) described above, since the first wall portion 311 extending in the circumferential direction and the welding portion 21W extending along the axis AX do not intersect with each other, the thermal stress of the welding portion 21W can be suppressed.

(6) In some embodiments, in the configuration of any one of (1) to (5) described above, a second wall 32 that is disposed on a side opposite to the first wall 31 across the supply port 25 (downstream-side supply port 25A) along the axis AX and that extends in the circumferential direction along the outer peripheral surface may be provided. The second wall 32 may include a second wall portion 321 that has a base end portion 321a connected to the outer peripheral surface 21c and extending in a direction away from the outer peripheral surface 21c and that extends in the circumferential direction, and a second discontinuous portion 326 in which the second wall portion 321 is discontinuous in the circumferential direction.

According to the configuration of (6) described above, since the second wall portion 321 can prevent the second cooling fluid, which is discharged from the discharge port 27 after cooling the downstream-side region 21B, from flowing from a side opposite to the first wall 31 across the supply port 25 (downstream-side supply port 25A) along the axis AX toward the supply port 25 (downstream-side supply port 25A), the decrease in cooling efficiency of the upstream-side region 21A can be suppressed. In addition, according to the configuration of (6) described above, since the second wall 32 has the second discontinuous portion 326, it is possible to suppress the thermal stress generated by the temperature difference between the tube body (transition piece 21) heated by the heat from the combustion gas Cg and the second wall portion 321, as compared with a case where the second wall portion 321 is continuously provided over the entire circumference of the tube body (transition piece 21) in the circumferential direction. As a result, the decrease in reliability of the tubular body for a combustor 12 can be suppressed.

(7) In some embodiments, in the configuration of (6), a top plate 34 that is connected to a distal end portion 311b of the first wall portion 311 on a side opposite to the base end portion 311a and to a distal end portion 321b of the second wall portion 321 on a side opposite to the base end portion 321a and that partially covers a space (casing internal space 10A) outside the tube body (transition piece 21) interposed between the first wall portion 311 and the second wall portion 321 may be provided.

According to the configuration of (7) described above, the second cooling fluid, which is discharged from the discharge port 27 after cooling the downstream-side region 21B, is less likely to flow into the space (space 10B in the casing internal space 10A) outside the tube body (transition piece 21) interposed between the first wall 31 and the second wall 32. The supply port 25 (downstream-side supply port 25A) is provided in a region, which is interposed between the first wall 31 and the second wall 32, on the outer peripheral surface 21c of the tube body (transition piece 21). Therefore, according to the configuration of (7) described above, the second cooling fluid, which is discharged from the discharge port 27 after cooling the downstream-side region 21B, is less likely to flow into the supply port 25 (downstream-side supply port 25A).

(8) In some embodiments, in the configuration of (6) or (7), a second cover member 352 that is disposed to cover at least a part of the second discontinuous portion 326 in the circumferential direction when viewed along the axis AX may be provided.

According to the configuration of (8) described above, since the second cover member 352 can suppress the second cooling fluid, which is discharged from the discharge port 27 after cooling the downstream-side region 21B, from flowing from the second discontinuous portion 326 toward the supply port 25 (downstream-side supply port 25A), the decrease in cooling efficiency of the upstream-side region 21A can be suppressed.

(9) In some embodiments, in the configuration of (8), the second cover member 352 may be fixed to the second wall portion 321 disposed on one side in the circumferential direction across the second discontinuous portion 326, and may not be fixed to the second wall portion 321 disposed on the other side in the circumferential direction across the second discontinuous portion 326.

According to the configuration of (9) described above, since the influence of the thermal elongation of the second wall portion 321 disposed on one side in the circumferential direction across the second discontinuous portion 326 is not transmitted via the second cover member 352 to the second wall portion 321 disposed on the other side in the circumferential direction across the second discontinuous portion 326. As a result, the thermal stress generated by the temperature difference between the tube body (transition piece 21) heated by the heat from the combustion gas Cg and the second wall portion 321 can be suppressed, and the decrease in reliability of the tubular body for a combustor 12 can be suppressed.

(10) In some embodiments, in the configuration of (8) or (9), a dimension Lc2 of the second cover member 352 in the circumferential direction may be larger than a dimension Lg2 of the second discontinuous portion 326 in the circumferential direction.

According to the configuration of (10) described above, since the second cover member 352 has the dimension in the circumferential direction required to cover the second discontinuous portion 326, the second cover member 352 can effectively prevent the second cooling fluid, which is discharged from the discharge port 27 after cooling the downstream-side region 21B, from flowing from the second discontinuous portion 326 toward the supply port 25 (downstream-side supply port 25A), and the decrease in cooling efficiency of the upstream-side region 21A can be effectively suppressed.

(11) In some embodiments, in the configuration of any one of (6) to (10) described above, the tube body (transition piece 21) may have a welding portion 21W extending along the axis AX in at least one or more locations in the circumferential direction. A position of the second discontinuous portion 326 in the circumferential direction may overlap a position of the welding portion 21W in the circumferential direction.

According to the configuration of (11) described above, since the second wall portion 321 extending in the circumferential direction and the welding portion 21W extending along the axis AX do not intersect with each other, the thermal stress of the welding portion 21W can be suppressed.

(12) A combustor 2 according to at least one embodiment of the present disclosure includes the tubular body for a combustor 12 according to the configuration of any one of (1) to (11), and a burner 14 that injects fuel.

According to the configuration of (12) described above, the decrease in cooling efficiency of the upstream-side region 21A of the tubular body for a combustor 12 can be suppressed. In addition, according to the configuration of (12), since the thermal stress generated by the temperature difference between the tube body (transition piece 21) heated by the heat from the combustion gas Cg and the first wall portion 311 can be suppressed, the decrease in reliability of the combustor 2 can be suppressed.

(13) A gas turbine GT according to at least one embodiment of the present disclosure includes the combustor 2 according to the configuration of (12), a compressor 1 that generates compressed air Ca to be delivered to the combustor 2, and a turbine 3 including a rotor 4 that rotates by means of a combustion gas Cg delivered from the combustor 2.

According to the configuration of (13) described above, the decrease in cooling efficiency of the upstream-side region 21A of the tubular body for a combustor 12 can be suppressed. In addition, according to the configuration of (13), since the thermal stress generated by the temperature difference between the tube body (transition piece 21) heated by the heat from the combustion gas Cg and the first wall portion 311 can be suppressed, the decrease in reliability of the combustor 2 and thus the gas turbine GT can be suppressed.

### REFERENCE SIGNS LIST

1: compressor
2: combustor
3: turbine
4: rotor
5: boosting device
10: casing (casing)
10A: casing internal space
11: combustor body
12: tubular body for combustor
21: transition piece (tube body)
21c: outer peripheral surface
21A: upstream-side region
21B: downstream-side region
21P: member
21W: welding portion
22: first cooling passage
23: second cooling passage
24: acoustic liner
25: supply port
25A: supply port (downstream-side supply port)
27: discharge port
28: supply port
30: mixing prevention portion
31: first wall
32: second wall
34: top plate
34a: opening
35: cover portion
311: first wall portion
311a: base end portion
311b: distal end portion
316: first discontinuous portion
321: second wall portion
321a: base end portion
321b: distal end portion
326: second discontinuous portion
351: first cover member
352: second cover member
354: top plate
354a: opening

1. A tubular body for a combustor, in which a combustion gas generated by combustion of fuel is flowable, the tubular body comprising:
a tube body extending along an axis;
a first cooling passage that is formed in an upstream-side region located on an upstream side of the tube body in a wall portion of the tube body, that has a supply port that is open to an outer peripheral surface of the tube body, and that is capable of cooling the upstream-side region by receiving a first cooling fluid introduced from a space outside the tube body through the supply port;
a second cooling passage that is formed in a downstream-side region located on a downstream side of the tube body with respect to the upstream-side region in the wall portion, that is capable of cooling the downstream-side region by receiving supply of a second cooling fluid different from the first cooling fluid, and that has a discharge port that is open to the outer peripheral surface at a position different from the supply port along the axis and through which the second cooling fluid is dischargeable to the space outside the tube body; and
a first wall that is disposed between the supply port and the discharge port and that extends in a circumferential direction of the tube body along the outer peripheral surface,
wherein the first wall includes a first wall portion that has a base end portion connected to the outer peripheral surface and extending in a direction away from the outer peripheral surface and that extends in the circumferential direction, and a first discontinuous portion in which the first wall portion is discontinuous in the circumferential direction.

2. The tubular body for a combustor according to claim 1, further comprising:
a first cover member that is disposed to cover at least a part of the first discontinuous portion in the circumferential direction when viewed along the axis.

3. The tubular body for a combustor according to claim 2,
wherein the first cover member is fixed to the first wall portion disposed on one side in the circumferential direction across the first discontinuous portion, and is not fixed to the first wall portion disposed on the other side in the circumferential direction across the first discontinuous portion.

4. The tubular body for a combustor according to claim 2,
wherein a dimension of the first cover member in the circumferential direction is larger than a dimension of the first discontinuous portion in the circumferential direction.

5. The tubular body for a combustor according to claim 1,
wherein the tube body has a welding portion extending along the axis in at least one or more locations in the circumferential direction, and
a position of the first discontinuous portion in the circumferential direction overlaps a position of the welding portion in the circumferential direction.

6. The tubular body for a combustor according to claim 1, further comprising:
a second wall that is disposed on a side opposite to the first wall across the supply port along the axis and that extends in the circumferential direction along the outer peripheral surface,
wherein the second wall includes a second wall portion that has a base end portion connected to the outer peripheral surface and extending in a direction away from the outer peripheral surface and that extends in the circumferential direction, and a second discontinuous portion in which the second wall portion is discontinuous in the circumferential direction.

7. The tubular body for a combustor according to claim 6, further comprising:
a top plate that is connected to a distal end portion of the first wall portion on a side opposite to the base end portion and to a distal end portion of the second wall portion on a side opposite to the base end portion and that partially covers a space outside the tube body that is interposed between the first wall portion and the second wall portion.

8. The tubular body for a combustor according to claim 6, further comprising:
a second cover member that is disposed to cover at least a part of the second discontinuous portion in the circumferential direction when viewed along the axis.

9. The tubular body for a combustor according to claim 8,
wherein the second cover member is fixed to the second wall portion disposed on one side in the circumferential direction across the second discontinuous portion, and is not fixed to the second wall portion disposed on the other side in the circumferential direction across the second discontinuous portion.

10. The tubular body for a combustor according to claim 8,
wherein a dimension of the second cover member in the circumferential direction is larger than a dimension of the second discontinuous portion in the circumferential direction.

11. The tubular body for a combustor according to claim 6,
wherein the tube body has a welding portion extending along the axis in at least one or more locations in the circumferential direction, and
a position of the second discontinuous portion in the circumferential direction overlaps a position of the welding portion in the circumferential direction.

12. A combustor comprising:
the tubular body for a combustor according to claim 1; and
a burner that injects fuel.

13. A gas turbine comprising:
the combustor according to claim 12;
a compressor that generates compressed air to be delivered to the combustor; and
a turbine including a rotor that rotates by means of a combustion gas delivered from the combustor.
